(19) United States
(12) Patent Application Publication
(10) Pub. No.: US 2008/0174082 A1
(43) Pub. Date: Jul. 24, 2008

(54) Lower control arm bushing

(76) Inventor: Donald D. Bunker, San Juan Capistrano, CA (US)

Correspondence Address: STETINA BRUNDA GARRED & BRUCKER, 75 ENTERPRISE, SUITE 250, ALISO VIEJO, CA, 92656, US

(21) Appl. No.: 11/657,245

(22) Filed: Jan. 24, 2007

(51) Int. Cl. B60G 7/02

(52) U.S. Cl. 280/124.109

(57) ABSTRACT

A bushing for a control arm comprises a cylindrical body portion defining a body portion axis and having a bore extending therethrough and defining a bore axis. The bushing further includes a laterally extending flange disposed about a periphery of opposing ends of the body portion. The bushing further includes a pair of cylindrical bosses protruding axially outwardly beyond the flanges. An annular recess is formed on each end of the body portion and is collectively defined by the body portion and the boss at each end. The annular recess is sized and configured to allow angular movement of the bore axis relative to a body portion axis.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND

The present invention relates generally to automotive components and, more particularly, to a uniquely configured bushing for a vehicle control arm assembly wherein the bushing is specifically adapted to be full-floating and non-binding for improved performance in vehicle handling and durability.

Incorporated into the front and rear suspensions of numerous automotive vehicles is a component referred to as a control arm. Vehicles typically equipped with control arms have upper and lower control arm assemblies which are used in conjunction with the suspension of the vehicle in order to manage the motion of the wheels relative to the motion of the vehicle body. With respect to the front suspension of the vehicle, each of the front control arm assemblies are typically mounted adjacent to the front wheels on opposing sides of the vehicle.

Similarly, with respect to the rear suspension, each of the two rear control arm assemblies are typically mounted adjacent the two rear wheels on opposing sides of the vehicle. Each control arm assembly typically includes the control arm itself and control arm bushings which are disposed within apertures located adjacent the opposed ends of the control arm. In control arms as currently known and manufactured, each of the control arm bushings is typically fabricated from rubber and are press-fit into a respective aperture at opposed ends of the control arm using an arbor press or other suitable device.

Each of the control arm bushings may be generally sized to protrude slightly outwardly from each end of the aperture into which it resides. Inserted into each of the control arm bushings is a tubular insert or sleeve which is typically of metallic construction and which includes a bore for receiving a pin or bolt for interconnecting the control arm assembly to the remaining front wheel suspension components.

As may be appreciated, over extended periods of time, factory-installed rubber control arm bushings used for cars, trucks and sport utility vehicles (SUV) deteriorate over time such that vehicle performance deteriorates and safety of the driver and passengers may be compromised. For example, torque forces imposed on the vehicle during high-speed cornering or during travel over uneven terrain compresses the rubber to the extent that the rubber may become permanently deformed. Permanent deformation of the bushing can result in loss of alignment (i.e., caster and camber) of the front wheels of the vehicle. In addition, permanent deformation of the rubber bushing can result in loss of steering response and reduced vehicle control which affects the overall safety of the vehicle.

Deterioration of rubber bushings can also occur due to exposure to oils, road salt, chemicals and other corrosives as well as exposure to atmospheric contaminants such as ozone and smog which can attack and degrade the rubber over time. Furthermore, rubber is known to shrink and harden over time due to loss of polymers from the rubber. The deleterious effects on vehicle performance as a result of worn, damaged or hardened control arm bushings is even more pronounced when vehicles are used in extreme conditions such as in off road driving and during competition such as in racing.

With control assemblies as currently known, once the control arm bushings become worn, the entire control arm assembly is typically removed from the vehicle and replaced with a new control arm assembly. Typically, the new control arm assembly includes control arm bushings manufactured of rubber and which are therefore subject to the same deleterious affects of the original rubber bushings. However, the control arm itself is typically undamaged and is typically acceptable for extended use on the vehicle once fitted with new control arm bushings. As may be appreciated, replacing the entire control arm assembly as opposed to only replacing the control arm bushings, results in significantly increased repair costs.

As can be seen, there exists a need in the art for control arm bushings that can be used as a replacement for worn rubber control arm bushings. Furthermore, there exists a need in the art for control arm bushings that can withstand the weight and torque forces that are known to degrade factory-installed rubber bushings commonly used in the prior art. In addition, there exists a need in the art for a control arm bushing that exhibit the correct stiffness or hardness for a given vehicle application in order to improve vehicle handling, cornering and overall control as well as maintain front end alignment of the vehicle over extended periods of time. Finally, there exists a need in the art for a control arm bushing which can be easily and quickly replaced without the need for replacing the entire control arm assembly and which is resistant to contaminants and corrosives which are known to destroy rubber bushings as used in the prior art.

### BRIEF SUMMARY

The present invention specifically addresses and alleviates the above-mentioned drawbacks associated with conventional control arm bushings of the prior art. More specifically, the present invention provides a bushing for a control arm for use on a suspension system of a vehicle. The control arm has opposing first and second ends with each of the first and second ends having cylindrical apertures extending laterally therethrough. Each of the apertures itself has opposing sides or ends which collectively define the width of the aperture.

The bushing is comprised of a cylindrical body portion having opposing bushing ends and an outer surface of the body portion. The body portion further defines a body portion axis extending therealong. An elongate cylindrical bore is coaxially disposed within the body portion. The bore extends through the body portion and defines a bore axis which is preferably coaxially aligned with the body portion axis. Each one of the opposing ends of the body portion preferably includes a laterally extending flange disposed about a periphery of the end of the body portion.

Each one of the flanges preferably has an outer peripheral edge having a beveled configuration. In addition, each one of the flanges preferably defines an inner annular shoulder formed opposite the outer peripheral edge. The inner annular shoulders of the opposing flanges are preferably spaced complimentary to the aperture width such that upon full installation of the bushing within the control arm, the bushing is captured within the aperture. When installed, each one of the inner annular shoulders is preferably in directly abutting contact with a respective one of the aperture ends.

The bushing further includes a pair of cylindrical bosses that are coaxially aligned with the body portion in a static mode (i.e., unloaded condition) of the bushing. The bosses protrude axially outwardly beyond a corresponding one of the flanges at a boss height. A pair of annular recesses are formed at each one of the opposing bushing ends. Each one of the annular recesses is collectively defined by the body portion and the boss. The annular recesses are sized and configured to allow for angular movement of the bore axis relative to the body portion axis without binding of the bushing within the control arm.

The bushing is sized and configured to be insertable into and to reside within at least one of the first and second apertures of the control arm. The boss may have a tapered boss outer surface while the body portion may have a tapered body portion inner surface such that the annular recess collectively defined thereby has a V-shaped cross section. The V-shaped cross section of the annular recess facilitates off-axis movement of the bore axis relative to the body portion axis as may occur when the bushing is in the loaded condition due to the imposition of torque forces or other loads on the control arm.

Installation of the bushing into the control arm is facilitated by providing the outer peripheral edge of at least one of the opposing flanges in a beveled configuration. Likewise, the flange includes an inner peripheral edge which is also preferably beveled. The beveled inner and outer peripheral edges intersect to define a circular edge on at least one of the flanges. The diameter of the circular edge is sized to facilitate installation of the bushing into the control arm at the aperture end thereof.

The opposing flange of the bushing may include a planar end surface collectively defined by the inner and outer peripheral edges of the flange. The planar end surface is preferably sized to provide sufficient area against which an arbor press may bear in order to axially force the bushing into the control arm at the aperture end. Installation of the bushing may be facilitated by impregnating the bushing material with graphite which acts as a lubricant. In further regard to the busing material, polyurethane is a preferable compound from which the bushing is fabricated as the polyurethane can be provided in the desired hardness or durometer reading in order to provide sufficient stiffness in the busing along a direction parallel to the bore axis. In this manner, the polyurethane bushing improves the performance characteristics of the vehicle suspension and steering as compared to rubber bushing of the prior art. Polyurethane also provides increased resistance to degradation as a result of exposure to atmospheric conditions and corrosives (i.e., oils, fluids) commonly used with motor vehicles.

### BRIEF DESCRIPTION OF THE DRAWINGS

These as well as other features of the present invention will become more apparent upon reference to the drawings wherein:

FIG. 1 is a perspective view of a control arm assembly having first and second ends for receiving a control arm bushing;

FIG. 2 is a perspective view of the control arm bushing illustrating a body portion having a boss extending axially outwardly therefrom;

FIG. 3 is a cross-sectional view of the control arm bushing as installed in the control arm; and

FIG. 4 is an end view of the control arm bushing illustrating the coaxial alignment of the boss with the body portion.

### DETAILED DESCRIPTION

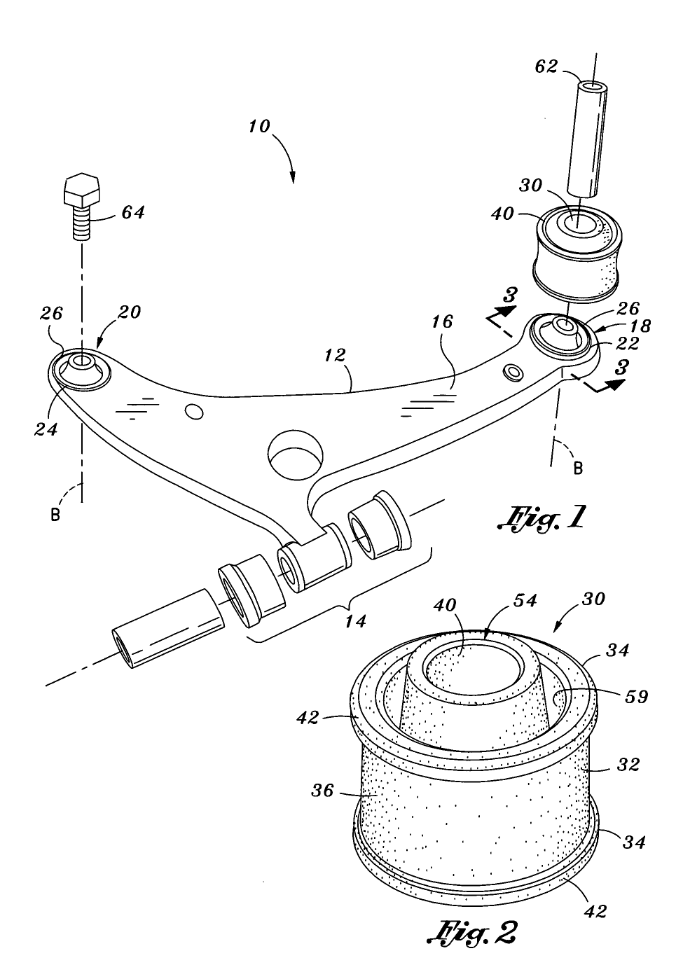

Referring now to the drawings wherein the showings are for purposes of illustrating preferred embodiments of the present invention only and not for purposes of limiting the same, FIG. 1 perspectively illustrates a vehicle control arm assembly 10 comprising a control arm 12 having a pair of bushings 30 installed in opposing first and second ends 18, 20 of the control arm 12.

As is known in the art, conventional factory-supplied rubber bushings are susceptible to sticking or binding in an off-axis orientation relative to the axis of the control arm 12 when the vehicle is operated under extreme conditions such as during off-road travel and during competition such as racing wherein the front suspension of a vehicle experiences extreme torque forces. Advantageously, the bushing 30 of the present invention is specifically configured to provide increased stiffness in the vertical direction (i.e., along the axis of the bushing) while allowing off-axis movement of the bushing 30 relative to the control arm 12 without binding of the bushing 30 in an off-axis orientation.

In addition, the control arm bushing 30 of the present invention is specifically adapted to operate in vehicles wherein the suspension ride height may have been altered or the vehicle is subjected to greater suspension loads. In this regard, the control arm bushing 30 of the present invention is specifically adapted to accommodate extreme off-axis movement of the bushing 30 relative to the control arm 12 into which it is installed while maintaining proper front wheel alignment. In addition, the bushing 30 of the present invention provides faster steering response with greater control than that which is achievable using conventional rubber bushings.

Referring to FIG. 1, shown is the control arm 12 having the bushings 30 installed on opposing first and second ends 18, 20 thereof. Each of the first and second ends 18, 20 of the control arm 12 includes a respective first and second cylindrical aperture 22, 24 which extends laterally through the control arm 12. Each of the apertures 22, 24 has opposing aperture edges or ends 26 which collectively define a width 28 of the aperture 22, 24. The control arm 12 itself is generally formed as an elongate member and may have a generally U-shaped or rectangular cross section formed by a rib member 16 extending between the first and second ends 18, 20.

Interposed between the first and second ends 18, 20 of the control arm 12 may be an additional horizontal bushing 14 which has an axis that is oriented perpendicularly relative to the axes of the control arm bushings 30 at the first and second ends 18, 20. A bolt or pin 64 may be inserted through a tubular insert 62 which is itself received within a bore 40 formed in each of the control arm bushings 30. The bolt or pin 64 serves to interconnect the control arm assembly 10 to the remaining suspension components of the vehicle.

Thus, each control arm assembly 10 includes two control arm bushings 30 which are disposed within each of the first and second ends 18, 20 of the control arm 12 as shown in FIG. 1. However, it should be noted that the specific configuration of the control arm 12 as illustrated in FIG. 1 is exemplary only and should not be construed as limiting the variety of different shapes, sizes and configurations of control arms 12 into which the bushings 30 of the present invention may be fitted. For example, it is contemplated that the control arm 12 may omit the horizontal bushing 14 illustrated in FIG. 1 and may instead include alternative features for interconnecting the control arm assembly 10 to the remaining suspension components of the vehicle.

Referring to FIG. 2, shown is a cross sectional view of the control arm assembly 10 illustrating the installation of the bushing 30 into one of the first and second cylindrical apertures 22, 24 formed in the control arm 12. As can be seen in FIGS. 1 and 2, the cylindrical apertures 22, 24 may be integrally formed with the control arm 12 which itself may be formed from a single piece of metal such as from a stamping operation. Alternatively, the control arm 12 may be integrally formed such as by machining from a single piece of metal.

Referring still to FIG. 2, each of the aperture ends 26 is sized and configured to receive one of the bushings 30. Each of the bushings 30 comprises a body portion 32 which is sized and configured complimentary to an interior of the cylindrical apertures 22, 24. FIG. 2 illustrates the bushing 30 having a cylindrical outer surface sized and configured complimentary to the cylindrical configuration of the aperture end 26. The body portion 32 of the bushing 30 has opposing bushing ends 34 and defines a body portion axis A extending through the bushing 30. An elongate cylindrical bore 40 is disposed within the body portion 32. The cylindrical bore 40 extends through the body portion 32 and defines a bore axis B which is preferably coaxially aligned with the body portion axis A.

The bushing 30 may further include a laterally extending flange 42 disposed about a periphery of each one of the opposing ends of the body portion 32. Each one of the flanges 42 may have an outer peripheral edge 46 that is sized to be slightly larger than the aperture end 26 into which the bushing 30 is insertable. Additionally, the flange 42 may further define an inner annular shoulder formed opposite the outer peripheral edge 46 such that the inner annular shoulders of the opposing flanges 42 are preferably spaced complimentary to the aperture width 28. In this manner, the bushing 30 may be captured within the aperture end. More specifically, the inner annular shoulders may have a spacing such that the inner annular shoulder are in directly abutting contact with a respective one of the aperture ends 26 so as to prevent axial movement of the bushing 30 relative to the control arm 12.

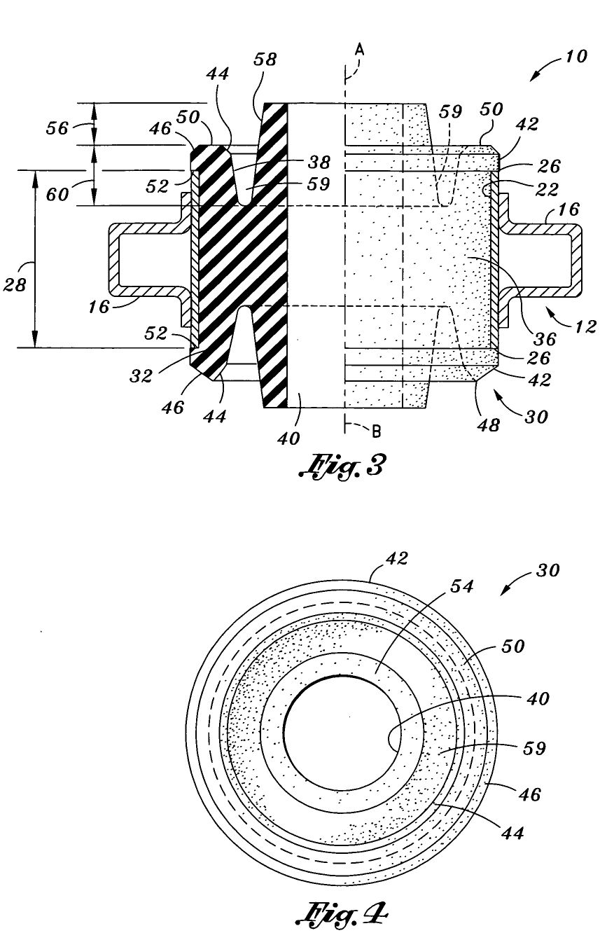

Referring to FIGS. 2-4, the bushing 30 preferably includes a pair of bosses 54 protruding axially outwardly beyond the flanges 42 at opposing ends of the body portion 32. The bosses 54 are preferably coaxially aligned with the flanges 42 and have the cylindrical bore 40 extending axially through the body portion 32 from the boss 54 on one end of the bushing 30 to the boss 54 on the opposing end of the bushing. As best seen in FIG. 2, the bosses 54 preferably extend axially beyond a corresponding flange 42 at a distance defined by a boss height 56. However, the bosses 54 may be configured to have a boss height 56 that is flush with or below the level of the aperture end 26.

Importantly, the bushing 30 includes a pair of annular recesses 59 formed at each one of the opposing aperture ends 26 of the body portion 32. The annular recesses 59 allow for off-axis movement of the bushing 30 relative to the control arm 12 without sticking or binding of the bushing 30 in the off-axis position as may occur in conventional bushings. The annular recess 59 is preferably sized and configured to allow angular movement (i.e., off-axis movement) of the bore axis B relative to the body portion axis A in a dynamic mode of the bushing. Each one of the annular recesses 59 is collectively defined by the body portion 32 and the boss 54 at each end of the bushing 30.

As can be seen in FIG. 2, the annular recess 59 preferably has an axial depth 60 that is approximately equivalent to the boss height 56 which is the distance beyond which the boss 54 protrudes from the flange 42. The annular recess 59 at each end of the bushing 30 is also preferably sized and configured to provide sufficient material to connect the body portion 32 to the opposing bosses 54. In this manner, the bushing 30 may resist vertical movement and provide sufficient stiffness in the vertical direction while still allowing for off-axis movement of the bushing 30. As was earlier mentioned, such off-axis movement is induced by wheel forces transmitted through adjacent suspension components via the pin or bolt 64 connected to adjacent suspension components.

As can be seen in FIG. 1, the pin or bolt 64 is received with the tubular insert 62 which may be configured as a metallic tubular sleeve and which is configured to be slidably receivable within the bore 40 of the bushing 30. The tubular insert 62 preferably has an outer diameter that is sized complimentary to the diameter of the bore 40 so as to provide a snug fit therebetween. The tubular insert 62 also preferably has an inner diameter that is sized complimentary to the diameter of the pin or bolt 64 that is insertable thereinto to provide a rigid connection to adjacent suspension components to which the control arm 12 is attached.

As can be seen in FIGS. 2 and 4, the boss 54 may be provided with a tapered boss outer surface 58 while the body portion 32 may be provided with a tapered body portion inner surface 38 such that the annular recess 59 has a V-shaped cross section. However, it should be noted that the body portion inner surface 38 and boss outer surface 58 may be configured in a variety of alternative configurations which collectively determine the cross sectional shape of the annular recess 59.

However, the configuration of the annular recess 59 illustrated in the figures is believed to be a preferable arrangement in order to allow sufficient off-axis movement of the bushing 30 relative to the body portion 32 while still maintaining sufficient structural stiffness against cornering and handling forces. In addition, the sizing of the annular recess 59 and its radial spacing from the body portion outer surface 36 is such that metal-to-metal contact between the pin or bolt 64 and the control arm 12 is prohibited. As may be appreciated, such metal-to-metal contact or binding of the bushing 30 which would otherwise give rise to diminished vehicle handling in addition to increasing the wear on the suspension components.

The outer peripheral edge 46 of the flange 42 at the opposing ends of the bushing 30 may have a beveled configuration in order to facilitate installation of the bushing 30 into the control arm 12. In this regard, the beveled configuration of the outer peripheral edge 46 is preferably formed at an angle that allows for initial engagement of the bushing 30 into the aperture end 26 of the control arm 12 by suitable means such as by using an arbor press. At least one of the flanges 42 preferably has an outer peripheral edge 46 sized such that the bevel extends inwardly to a diameter that is smaller than the diameter of the aperture end 26. The flange 42 may also include an inner peripheral edge 44 which may be provided with a beveled configuration.

As can be seen in FIG. 2, the right-hand side of the bushing 30 may be configured such that the beveled inner and outer peripheral edges 44, 46 of the flange 42 intersect one another to define a circular edge 48 feature in order to better facilitate insertion of the bushing 30 into the control arm 12. The left-hand side of the bushing 30 may be configured such that the beveled inner and outer peripheral edges 44, 46 are radially spaced to define a circular planar end surface 50 which preferably provides sufficient cross sectional area against which a suitable mechanism such as an arbor press may be borne.

In this regard, sufficient force is applied to the planar end surface 50 in order to axially move the bushing 30 relative to the control arm 12 until the flanges 42 at opposing ends of the bushing 30 protrude from each side of the aperture end 26 of the control arm 12. As was earlier mentioned, the flanges 42 are provided with inner annular shoulders 52 that are preferably spaced apart in order to allow for capturing of the bushing 30 within the aperture of the control arm 12. The first and second aperture 22, 24 are preferably formed at an aperture diameter with the circular edge 48 on the one side of the bushing 30 having a diameter that is smaller than the aperture diameter.

The control bushing 30 may be fabricated of a suitable resilient non-metallic material such as a polymeric material having sufficient hardness. A preferred polymeric material is a polyurethane compound which is specifically formulated to exhibit a durometer reading (e.g., Shore hardness) that provide the desired stiffness along the bore axis B of the bushing 30 while still allowing for off-axis movement (i.e., movement of the bore axis B relative to the body portion axis A) without the problem of binding of the bushing 30 in the aperture end 26.

In addition, the polyurethane is preferably formulated to provide high resistance to degradation caused by environmental factors such as contamination via corrosive fluids such as gas, oil, transmission fluid, brake fluid, power steering fluid as well as road salt and ozone or smog. Furthermore, the polyurethane compound from which the bushing 30 is fabricated preferably provides extended life for the bushing 30 as compared to conventional bushings 30 fabricated of conventional rubber compounds which are known to rot or deteriorate due to exposure to oils or atmospheric conditions. The polyurethane compound is also formulated in order to resist permanent deformation of the polyurethane during the repeated application of extreme torque and loads imposed thereon. Optionally, the polyurethane compound may be impregnated with graphite in order to provide a lubricating quality to the bushing 30 which facilitates installation of the bushing 30 into the control arm 12 and which also facilitates slidable insertion of the tubular insert 62.

Installation and operation of the bushing 30 and the control arm 12 will now be described with reference to the figures. After removing the control arm 12 from the vehicle, the bushings 30 to be replaced may be removed from the control arm 12 by first applying heat to the area around the aperture end 26 of the control arm 12 using any suitable heat source such as a propane or butane torch. Preferably, the heat is applied along the outer side of the aperture end 26 in order to break the bond between the rubber bushing 30 and the aperture end 26. After breaking the bond between the bushing 30 and the control arm 12, a suitable instrument such as a flatblade screwdriver may be used to pry or push the bushing 30 out of the aperture end 26 until the bushing 30 is completely removed from the control arm 12. The bushing 30 may be discarded and the interior of the control arm 12 may then be cleaned of residual debris and remnants of the rubber bushing.

The polyurethane bushing 30 may then be installed by first lubricating the flange 42 having the circular edge 48 and lubricating the outer peripheral edge 46 of the flange 42 and the body portion outer surface 36. An arbor press may be placed against the opposing flange 42 on the planar surface and the bushing 30 may be axially forced into the aperture end 26 by press-fitting until the flange 42 is protruding from opposing sides of the aperture end 26. In this position, the inner annular shoulders 52 of each of the flanges 42 are preferably in directly abutting contact with the aperture ends 26. The tubular insert 62 may then be inserted into the bore 40 of the bushing 30. The procedure is repeated for installation of the bushing 30 in the second end 20 of the control arm 12. The control arm assembly 10 may then be reinstalled in the vehicle using the appropriate mechanical hardware.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A bushing for a control arm, comprising:
a body portion having opposing ends and defining a body portion axis;
an elongate cylindrical bore extending therethrough and defining a bore axis;
a laterally extending flange disposed about a periphery of at least one of the opposing ends, the flange having an outer peripheral edge, the flange defining an inner annular shoulder formed opposite the outer peripheral edge;
a boss protruding axially outwardly beyond the flange at a boss height; and
an annular recess interposed between and being collectively defined by the body portion and the boss, the annular recess being sized and configured to allow angular movement of the bore axis relative to the body portion axis.

2. The bushing of claim 1 wherein the annular recess has an axial depth that is substantially equivalent to the boss height.

3. The bushing of claim 1 wherein the boss has a tapered outer surface and the body portion has a tapered inner surface such that the annular recess has a V-shaped cross section.

4. The bushing of claim 1 wherein the outer peripheral edge of the flange has a beveled configuration.

5. The bushing of claim 4 wherein the flange includes an inner peripheral edge having a beveled configuration.

6. The bushing of claim 5 wherein the beveled inner and outer peripheral edges are radially spaced to define a planar end surface of the flanges.

7. The bushing of claim 5 wherein the beveled inner and outer peripheral edges intersect to define a circular edge of the flanges.

8. The bushing of claim 8 wherein the non-metallic material is a polymeric material.

9. The bushing of claim 8 wherein the polymeric material is a polyurethane compound.

10. The bushing of claim 9 wherein the polyurethane compound is impregnated with graphite.

11. A vehicle control arm assembly, comprising:
a control arm having opposing first and second ends and first and second cylindrical apertures extending laterally through the control arm at respective ones of the first and second ends, each of the apertures having opposing aperture ends defining an aperture width;
a bushing, comprising:
a cylindrical body portion having opposing bushing ends and an outer surface and defining a body portion axis;
an elongate cylindrical bore coaxially disposed within the body portion and extending therethrough and defining a bore axis being coaxially aligned with the body portion axis;
a laterally extending flange disposed about a periphery of each one of the opposing ends of the body portion, each one of the flanges having an outer peripheral edge and defining an inner annular shoulder formed opposite the outer peripheral edge;
a pair of cylindrical bosses coaxially aligned with and protruding axially outwardly beyond a corresponding one of the flange at a boss height; and
a pair of annular recesses formed at each one of the opposing bushing ends, each one of the annular recesses being collectively defined by the body portion and the boss and being sized and configured to allow angular movement of the bore axis relative to the body portion axis.
wherein:
the bushing is sized and configured to be insertable into at least one of the first and second apertures.

12. The bushing of claim 11 wherein the annular recess has an axial depth that is substantially equivalent to the boss height.

13. The bushing of claim 11 wherein the boss has a tapered boss outer surface and the body portion has a tapered body portion inner surface such that the annular recess has a V-shaped cross section.

14. The bushing of claim 11 wherein the outer peripheral edge of the flange has a beveled configuration.

15. The bushing of claim 14 wherein the flange includes an inner peripheral edge having a beveled configuration.

16. The bushing of claim 15 wherein the beveled inner and outer peripheral edges are radially spaced to define a planar end surface of the flange.

17. The bushing of claim 15 wherein the beveled inner and outer peripheral edges intersect to define a circular edge of the flange.

18. The vehicle control arm assembly of claim 11 further comprising a tubular insert configured to be slidably receivable within the bore.

19. The vehicle control arm assembly of claim 11 wherein the opposing flanges are spaced complementary to the aperture width such that the bushing is captured within the aperture.

20. The vehicle control arm assembly of claim 19 wherein each one of the inner annular shoulders is configured to be in directly abutting contact with a respective one of the aperture ends.
